(19) United States
(12) Patent Application Publication
(10) Pub. No.: US 2002/0065669 A1
(43) Pub. Date: May 30, 2002

(54) Method and system for provisioning customized telecommunications circuits

(75) Inventors: Patrick C. Shutt, Chicago, IL (US); Robert J. Pommer JR., Glenview, IL (US)

Correspondence Address: BRINKS HOFER GILSON & LIONE, P.O. BOX 10395, CHICAGO, IL, 60610, US

(73) Assignee: Universal Access, Inc.

(21) Appl. No.: 09/727,949

(22) Filed: Nov. 30, 2000

(51) Int. Cl. G06F 17/60

(52) U.S. Cl. 705/1; 455/3.04

(57) ABSTRACT

A method and system for provisioning a customized telecommunications circuit between two terminal points is provided, wherein an facilitator provisions the circuit on behalf of a customer. According to one method customer request for a circuit between the terminal points is received. A plurality of network parameters relating to the customer request are then evaluated by consulting a database of information relating to a plurality of available network segments from separate transport suppliers. At least one customized circuit option is identified, and a plurality of network segments from separate transports suppliers is linked via at least one facilitator-controlled exchange facility to form a provisioned circuit between the terminal points. Access to the provisioned circuit is then provided to the customer.

### BACKGROUND OF THE INVENTION

The present invention generally relates to telecommunications circuits. In particular, the invention relates to the provisioning and linking of customized, point-to-point, dedicated circuits for use with telecommunications systems.

Within the telecommunications industry, there is an increasing market for customized, point-to-point dedicated circuits, or leased lines. Typically, these circuits are “provisioned” via transport suppliers to provide the requested point-to-point service. “Provisioning” conventionally refers to the supplying of telecommunications service to a user, and may include the assignment of transmission, equipment, switching, wiring and bandwidth to the customer associated with that service. For example, a customized circuit may provide dedicated communications bandwidth between a customer's facilities in two different cities. These circuits have traditionally been provisioned by one of the many transport suppliers in the telecommunications industry. Each transport supplier generally has its own network over which dedicated circuits may be provisioned.

There are limitations, however, to a transport supplier's ability to provision circuits on its own network. First, most suppliers' networks are limited geographically. Because it is expensive to build and maintain large networks, few suppliers are able to maintain networks that serve a large number of locations. In addition, networks have limited capacity. Once capacity is reached for a given segment of a supplier's network, additional circuits must be routed around that segment. Finally, different types of suppliers maintain different types of networks. For instance, different suppliers serve various local, regional, national, and global markets. A national supplier maintains long-distance circuits, but might not be able to provide a local connection to a customer's facility. Likewise, a local supplier may not have access to the long-distance circuits required by a given customer or end-user. Furthermore, the control of entire circuits by a single supplier may result in increased costs for customers of the circuits.

For these reasons, transport suppliers often provision portions of circuits “off-network.” This requires a first supplier to negotiate with a second supplier to obtain access to the second supplier's network. If the two suppliers are competitors, the negotiations can be difficult and inefficient. The result is that the customer may pay more and wait longer than should be necessary to obtain access to a dedicated circuit. Moreover, provisioning portions of a circuit off-network requires interconnection of the network segments of at least two different transport suppliers. This often involves physical connection of the circuit from one facility to another, which can result in additional delays.

Telecommunications customers may also suffer from a lack of information about internal operations within the industry or with a particular transport supplier. In addition, the somewhat esoteric properties of the provisioning process itself may be difficult to discern. For instance, the complex process of provisioning a circuit typically includes meeting a number of “critical dates,” or deadlines, within the process before the circuit can be operational. If the customer is unaware of the scheduling process, a critical date can be missed. The result is often a delay in provisioning the circuit or the loss of the opportunity to provision the circuit. However, if the customer is aware of the provisioning schedule, the customer is in a better position to monitor the transport supplier and ensure that the circuit is provisioned on time. There are other details of the provisioning process, such as real-time availability, capacity, and pricing of particular network segments, that, if known to the customer, could help ensure that the customer gets the best available circuit and that the circuit is provisioned on schedule. Customers generally are not aware of these provisioning details, however, because suppliers usually do not share them with customers.

It is therefore an object of this invention to provide customers with updated network parameter information from a variety of transport suppliers.

It is a further object of this invention to provide an improved method and system for provisioning customized circuits wherein customers are able to conveniently order and obtain access to circuits involving the networks of a variety of transport suppliers.

It is another object of this invention to provide an improved method and system for provisioning customized circuits wherein multiple network segments from various transport providers may be linked via neutral exchange facilities.

It is yet another object of this invention to provide an improved method and system for provisioning customized circuits wherein multiple network segments from various transport providers may be provisioned and linked according to an automated process in response to a specific order.

### BRIEF SUMMARY OF THE PREFERRED EMBODIMENTS

In accordance with the present invention, a method and system are described for provisioning customized, dedicated point-to-point circuits. According to one aspect of the invention, a method relates to a facilitator that provisions the circuit and then provides a customer/end-user with access to the circuit. The method includes the step of receiving a customer request for a circuit between at least two terminal points. Network parameters related to the customer request are then evaluated, after which a plurality of network segments from separate transport suppliers are linked. The network segments may be linked via facilitator-controlled exchange facilities to form a provisioned circuit between the customer-specified terminal points. Access to the circuit is then provided to the customer.

According to another aspect of the invention, a method of obtaining a provisioned circuit between at least two terminal points is described. The method includes the step of requesting from a facilitator a circuit between the terminal points. At least one circuit option is then received from the facilitator in accordance with the request. Each circuit option includes a plurality of network segments from separate transport suppliers, wherein the network segments may be linked via at least one facilitator-controlled exchange facility to form a complete circuit. One of the circuit options is then selected to be a provisioned circuit, and access to the provisioned circuit is then received.

According to yet another aspect of the invention, a system for provisioning a circuit between at least two terminal points is described. The system includes at least one processing server serving a plurality of customers. A database resides on the processing server. The database is updated on a regular basis with information related to a plurality of network segments of various transport suppliers. The information is received from the plurality of transport suppliers. A plurality of exchange facilities are provided, in communication with at least one of the servers to assist in the linking of network segments. Logic software also resides on the server. The logic software is in communication with the database and the exchange facilities to automate the linking of the network segments via the exchange facilities to form a provisioned circuit in accordance with a customer request.

The invention provides several advantages over known methods and systems. Customers are provided with network parameter information for network segments maintained by different transport suppliers. This information may be updated on a real-time basis. End-users are thus able to conveniently order and obtain access to circuits involving the networks of a variety of transport suppliers. Individual network segments comprising a customized circuit are linked via neutral exchange facilities. Moreover, the linking of network segments from different transport suppliers may be performed automatically in response to a customer order.

The invention and its various advantages will become more apparent to those skilled in the art from the ensuing detailed description of preferred embodiments, reference being made to the accompanying drawings.

### BRIEF DESCRIPTION OF THE DRAWINGS

The subsequent description of the preferred embodiments of the present invention refers to the attached drawings, wherein:

FIG. 1 is a block diagram of a typical point-to-point circuit connecting a customer's facilities in Los Angeles and New York City;

FIG. 2 is a block diagram of a system for provisioning customized circuits according to one presently preferred embodiment of the invention;

FIG. 3 is a block diagram of an information exchange according to another presently preferred embodiment of the invention;

FIG. 4 is a flow diagram depicting a method of provisioning a customized circuit according to yet another presently preferred embodiment of the invention;

FIG. 5 is a block diagram of an exemplary provisioned circuit between end-user facilities in Los Angeles and New York City according to still another presently preferred embodiment of the invention; and

FIG. 6 is a flow diagram depicting a method of ordering a customized circuit according to a further presently preferred embodiment of the invention.

### DETAILED DESCRIPTION OF THE PREFERRED EMBODIMENTS

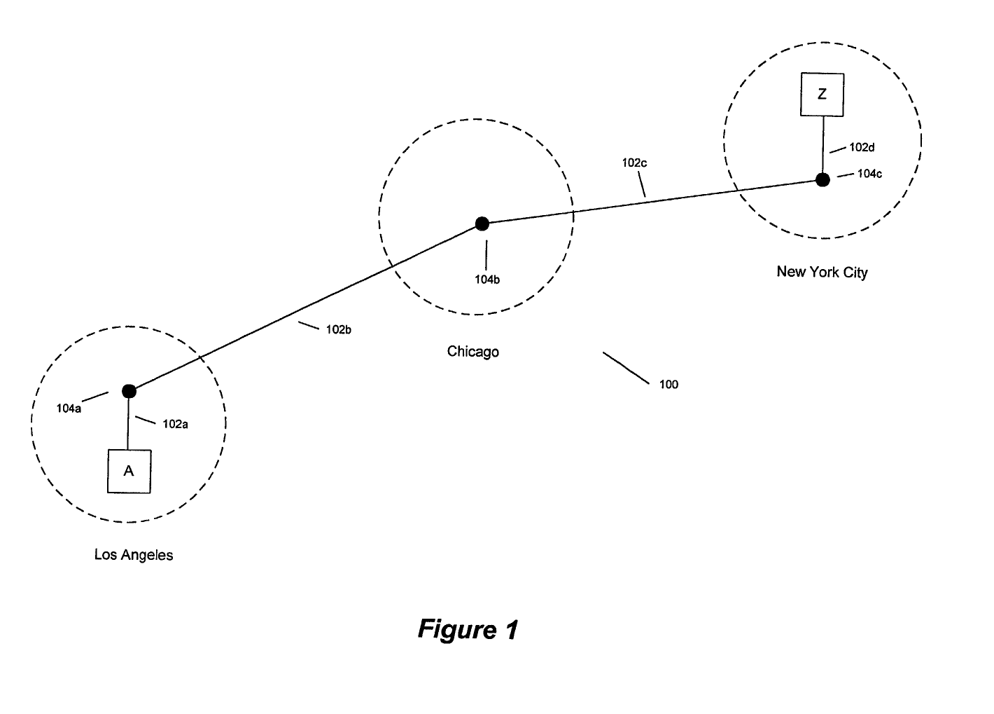

Referring now to the accompanying drawings, FIG. 1 shows the components of a typical dedicated point-to-point telecommunications circuit 100. The circuit 100 comprises a plurality of network segments 102a-d. Each network segment 102a-d is a portion of a transport supplier's network that connects two points on the network, and may be linked with other network segments to form a point-to-point circuit between desired destinations. For instance, a national transport supplier may maintain a network segment 102b between Los Angeles and Chicago, and another network segment 102c between Chicago and New York City. These network segments 102b,c may be linked together to form a single circuit between Los Angeles and New York City.

National transport suppliers typically do not maintain local networks in every city. Instead, the long-distance network segments maintained by a national transport supplier terminate in one or more centralized interconnection facilities 104a-c within a city. Accordingly, if a customer wants a dedicated circuit from its particular location A in Los Angeles to a location Z in New York City, local network segments 102a, d are used to provide a localized connection between the termination points of the longdistance segments 102b, c and the particular customer locations A,Z. For instance, the local segment 102a provides a connection between the customer location A in Los Angeles and the termination point of the long-distance segment 102b. Likewise, local segment 102d provides a connection between the customer location Z in New York City and the termination point of the long-distance segment 102c. The requested circuit from location A to location Z is thus formed via the connection of four network segments 102a-d.

Depending upon the location of the customer's facilities, there may be more than one local network segment 102a,d at each end of the circuit 100. Multiple local network segments 102a,d may be required to extend the circuit 100 to the customer's facilities. For instance, if the local transport supplier that provides the a necessary local network segment 102a can only provide a connection to the customer's building, but not to the customer's facilities within that building, an additional network segment may be required. This “building riser” network segment (not shown) extends within the building from the local transport supplier's connection to the customer's facilities.

As discussed above, the local network segments 102a,d typically are not provided by the same transport suppliers as the long-distance network segments 102b,c. As a result, the network segments 102a-d combined to form a single point-to-point circuit 100 often are maintained by more than one transport supplier. A first transport supplier may provide the local network segment 102a in Los Angeles, and a second transport supplier may provide the local network segment 102d in New York City. A third supplier may then provide the long-distance network segments 102b,c. In fact, each of the two long-distance network segments 102c also may be provided by a different transport supplier, depending upon the scope and availability of each transport supplier's network. As a result, up to four different transport suppliers may be responsible for providing the network segments 102a-d that form the customer's circuit 100 in FIG. 1.

Connections between network segments 102 maintained by different transport suppliers are created at the interconnection facilities 104a-c. Typically, one transport supplier “co-locates” connection equipment at the interconnection facility of another transport supplier by leasing space for the equipment in the facility. Connection of one segment to another is accomplished by physically connecting the equipment of one supplier to that of another or by programming a control system to logically connect the network segments within the interconnection facility. If a customized circuit requires connection of network segments from two different transport suppliers that do not maintain co-located equipment, a connection must be constructed by running a new network segment between the interconnection facilities of the two transport suppliers.

The provisioning of circuits involving multiple transport suppliers as herein described can result in excessive costs and inefficiencies to the customer or end-user. Moreover, the central interconnection facilities 104a-c are each typically controlled by a separate transport supplier, and many transport suppliers are reluctant to grant their competitors access to proprietary interconnection facilities 104a-d for purposes of linking network segments 102a-d. Accordingly, if the customer orders the entire circuit 100 through a single transport supplier, that transport supplier must negotiate with the other transport suppliers to provision segments of the circuit 100 “off-network” and to gain access to specific connection facilities 104. These negotiations may be difficult and inefficient. Alternatively, the customer may order each network segment 102 directly from the relevant transport supplier. It is the customer that then must negotiate with the transport suppliers to ensure that the network segments 102 are properly interconnected. Either way, the customer usually must interface with all four transport suppliers to pay for and maintain the customized circuit 100.

According to at least one embodiment of the present invention, an information exchange is provided to reduce the inefficiencies of provisioning a point-to-point circuit, and to provide a single resource for ordering and maintaining the circuit. The information exchange is part of a system for provisioning customized dedicated point-to-point circuits.

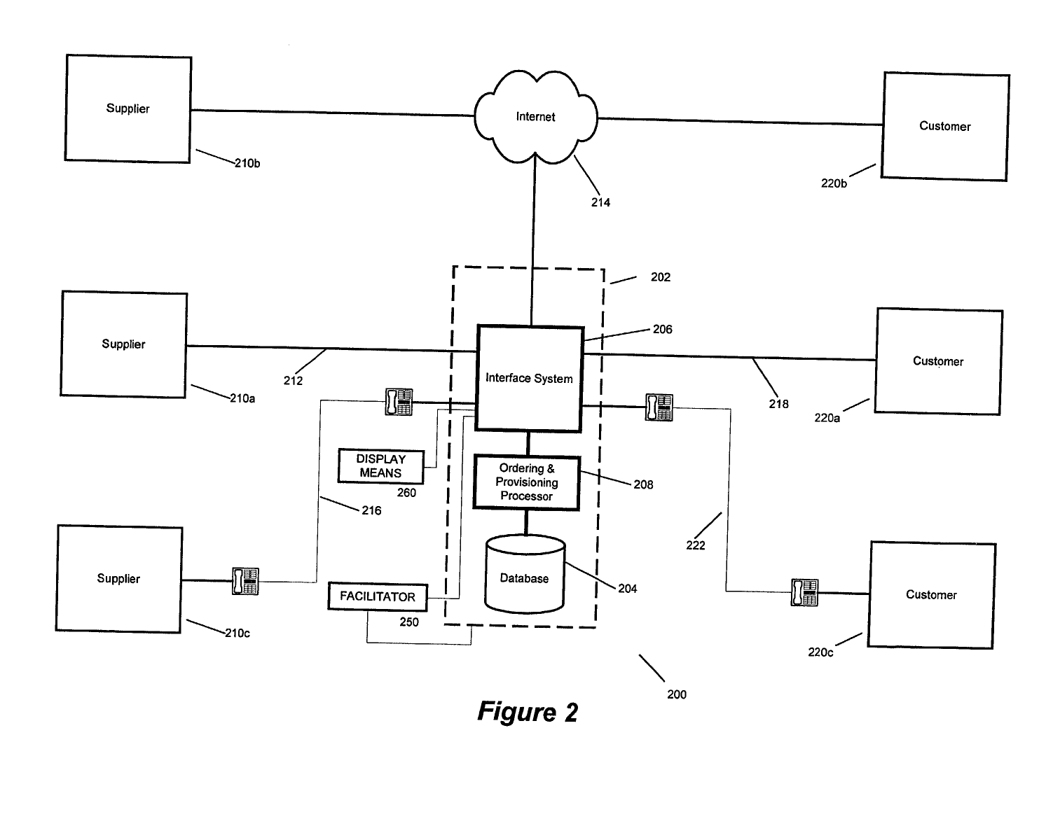

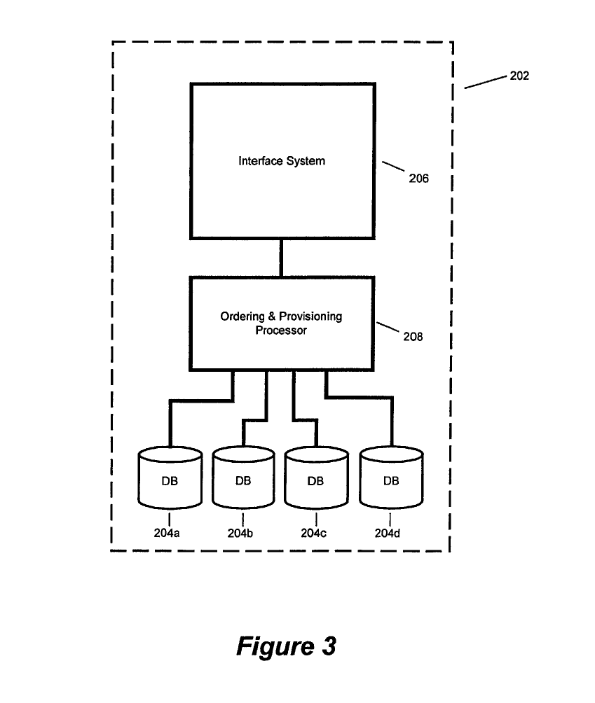

FIG. 2 shows a first embodiment of a circuit provisioning system, designated generally by the numeral 200, according to this invention. An information exchange 202 is provided which includes a proprietary database 204 containing various types of information related to the provisioning of circuits. The information exchange 202 acts as a processing server to serve customers in response to requests and orders. Depending upon system requirements, the database 204 may actually consist of a plurality of interconnected databases 204a-d, as shown in FIG. 3. For instance, separate databases 204a-d may be maintained to track network parameter information, quote information, customer information, and billing information. The network parameter information contained in the database 204 may include information relating to capacity, availability, physical location, and pricing information from a variety of transport suppliers. Preferably, network parameter information is maintained for a plurality of individual network segments 102 available from the transport suppliers. This facilitates evaluation of network parameters on a per-segment basis.

Network parameter information for a given network segment 102 is preferably obtained from the transport supplier that maintains the network segment 102. Preferably, the database 204 is updated frequently to provide the most recent information possible. Most preferably, the information exchange is connected directly to the databases of transport suppliers such that the database 204 of the information exchange 202 is updated instantly when a supplier's database is updated. In this case, the information exchange 204 provides real-time data on network parameters.

The information exchange 202 is preferably maintained by a facilitator 250 that is able to interface directly with transport suppliers to obtain network parameter information and to arrange for circuit provisioning. The facilitator 250 may be an agent that orders network segments 102 and circuits 100 from transport suppliers on behalf of a customer. However, it is important to note that the facilitator may also be other than a mere agent. The facilitator may act as principle in both the buying and selling of circuits. For example, the facilitator is the party of record in all service agreements with transport suppliers. The facilitator may then sell the circuits to its own customers, who become the “end-users” of the circuits. According to thisembodiment, the end-users gain the advantage of being anonymous to the transport suppliers providing the network segments that make up the circuit. Another advantage gained when the facilitator 250 acts as the buyer of record in all transactions with transport suppliers comes from the economics of scale. The facilitator is able to negotiate more competitive rates by committing to purchase a large fixed amount of network access from particular transport suppliers. The savings in cost may then be passed on to the end-user, resulting in less expensive circuits for the facilitator's customers.

It is also important to note that the facilitator 250 need not necessarily be one person. The facilitator may be several persons within a single entity or several entities, or a corporate entity itself. Furthermore, the facilitator may also comprise an automated or intelligent system or software program configured to interface with transport suppliers and customers.

The information exchange 202 also enables the facilitator 250 to provide customers with a single point of contact for the provisioning, installation, and maintenance of circuits from multiple transport suppliers, as well as circuit access and network management.

The information exchange 202 includes an interface system 206 to facilitate communications by the facilitator 250 with customers and transport suppliers. The interface system 206 is preferably linked to an automated ordering and provisioning system 208, which in turn is linked to the information exchange database 204. The interface system 206 facilitates communication with transport suppliers in a number of ways. Preferably, a direct connection 212 is provided between a transport supplier 210a and the information exchange interface 206. Alternatively, a transport supplier 210b may connect to the information exchange interface 206 via the Internet 214. In this case, the connection via the Internet 214 is preferably secure. A transport supplier 210c may also connect to the information exchange interface 206 via a standard public switched telephone network (PSTN) connection 216. For instance, communications between the transport supplier 210c and the information exchange interface 206 via a PSTN connection may take the form of data, facsimile, voice, or a combination thereof. In the case of facsimile and voice communications, the facilitator 250 that maintains the information exchange facilitates the communication.

Through these various forms of communication with transport suppliers, the facilitator 250 and the information exchange interface 206 are able to update the information exchange database to represent current network parameter information. The facilitator 250 and the information exchange 202 are also able to place orders with transport suppliers 210 for access to particular network segments 102. During the provisioning and installation process, the facilitator 250 and the information exchange 202 are able to monitor the progress of the transport suppliers to ensure that no critical dates are missed and that the circuit is available to the customer on schedule. When the provisioning process is complete, the facilitator is then able to monitor and maintain the circuit on behalf of the customer.

This system eliminates the inefficiencies of traditional circuit provisioning in a number of ways. First, the facilitator 250 is able to order circuits directly from a wide variety of transport suppliers. The information contained in the information exchange database 204 allows the facilitator to offer customers many or all of the available circuit options from the various transport suppliers. For example, a customer may choose to order different network segments 102 of a circuit 100 from different transport suppliers. The customer may compare a variety of network parameters, such as price, capacity, and availability, for various circuit segments by consulting the information exchange database 204. The customer may then choose the best circuit option based on these parameters. Alternatively, the facilitator 250 may filter the available options based on predetermined customer preferences and provide only the one or more options that most closely match those preferences.

The information exchange 202 also eliminates inefficiency by providing the facilitator 250 with information regarding the provisioning and scheduling processes of various transport suppliers. Each transport supplier has its own set of operating procedures by which circuits are provisioned. These procedures typically include a series of critical dates that occur during the provisioning process. If certain necessary events do not occur before a critical date, the entire provisioning schedule may be delayed. The delays can be substantial, and can result in excessive costs to the customer.

Because the customer is typically not aware of pending critical dates in the provisioning process, the customer may not realize that the process is behind schedule before additional costs are incurred. By maintaining information regarding the scheduling and operating procedures for each transport supplier in the information exchange, 202 the facilitator 250 is able to monitor the provisioning process and to anticipate critical dates. The facilitator 250 may then take affirmative action to ensure that each critical date in the provisioning process is met. The facilitator thereby ensures a more dependable and predictable provisioning process.

The interface system 206 of the information exchange 202 also facilitates communication with customers in a number of ways. For instance, a direct connection 218 may be provided between a customer 220a and the information exchange interface 206. Alternatively, a customer 220b may access the information exchange interface 206 via the Internet 214. In this case, the connection via the Internet 214 is preferably secure. A customer 220c may also connect to the information exchange interface 206 via a PSTN connection 222. For instance, communications between the customer 220c and the information exchange interface 206 via a PSTN connection may take the form of data, facsimile, or voice. In the case of facsimile and voice communications, the facilitator that maintains the information exchange facilitates the communication.

Communications with customers via the information exchange 202 include providing a customer with network parameter information relating to a number of available circuit options connecting network segments 102 from a variety of transport suppliers, and receiving customer orders for customized circuits. The facilitator 250 may also provide the customer with quotes or estimated pricing before an order is received. The information exchange 202 may also offer a customer with single-point network management services for provisioned circuits.

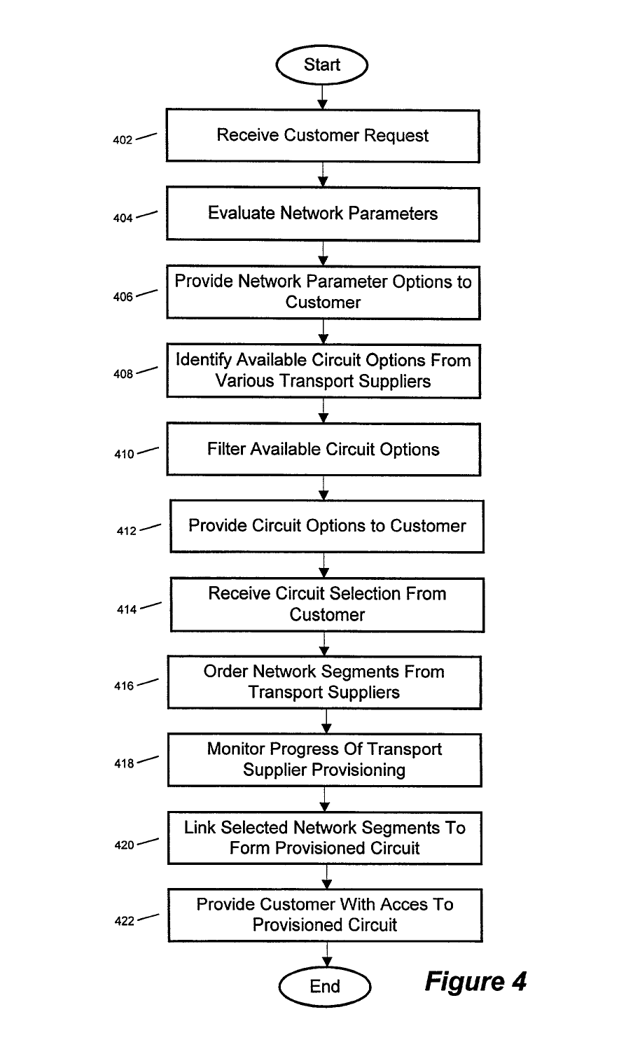

The process of provisioning a circuit according to a preferred embodiment of this invention will now be discussed with reference to the flow chart of FIG. 4. One or more individual steps of the method may be performed automatically by the interface system 206 and the automated ordering and provisioning system 208 in connection with the information exchange database 204. First, the facilitator 250 receives a request for a customized circuit from a customer in step 402. The customer order is preferably received via the interface system 206 and the automated ordering and provisioning system 208 of the information exchange 202. In the order, the customer may specify certain network parameters such as the terminal points of the circuit, preferred capacity, particular routing information, and the date by which the customer needs access to the circuit. The preferred capacity may be, for example, particular digital service or optical carrier levels such as DS-1, DS-3, OC-3, OC-12, OC-48, OR OC-192. The customer may also specify preferred transport suppliers, as well as particular circuit features such as fiber/copper, redundant/non-redundant, SONET/non-SONET, and protected/non-protected.

After receiving the customer's order, the facilitator 250 evaluates the network parameters of available network segments 102 that might be combined to fulfill the customer's order (step 404). This may be done by consulting the network parameter information contained in the information exchange database 204, a computer interface display 260 or other suitable display means. Optionally, the facilitator 250 may provide the customer with further network parameter options in step 406. Based on the results of the evaluation and any response received from the customer, the facilitator 250 identifies the customized circuit options that are available to fulfill the customer's order in step 408. The available circuit options may offer different routing options, as well as different combinations of network segments 102 from various transport suppliers. Circuit options may also vary by price and scheduling availability. In step 410, the facilitator 250 optionally may then filter the available circuit options to identify those circuit options that most closely match the customer's request. The facilitator 250 then provides a list of circuit options to the customer in step 412, and receives the customer's circuit selection in step 414.

The customer's circuit selection indicates to the facilitator 250 which network segments 102 from which transport suppliers the customer would like to use. Based on this information, the facilitator 250 orders provisioning of the proper network segments 102 from their respective transport suppliers in step 416. As described above, the facilitator 250 as an entity becomes the party of record with respect to all service agreements with the transport suppliers. Accordingly, the end-user may remain anonymous to the transport suppliers that supply the network segments of the provisioned circuit. During the provisioning process, the facilitator 250 optionally may monitor the progress of the transport suppliers in step 418 to ensure that no critical dates are missed and that the customer's circuit will be provisioned on schedule. After the transport suppliers have provisioned each network segment, the facilitator links the terminal points of the proper network segments 102 together to form the circuit in step 420. The facilitator may itself link the terminal points of the network segments via facilitator-controlled exchange facilities. Alternatively, the facilitator may request that one or more transport suppliers provide the link between network segments. Either way, the facilitator then provides the customer with access to the provisioned circuit in step 422. Thereafter, the facilitator serves as a single point of contact for the customer in connection with all billing and circuit maintenance procedures relating to each of the network segments 102 of the provisioned circuit.

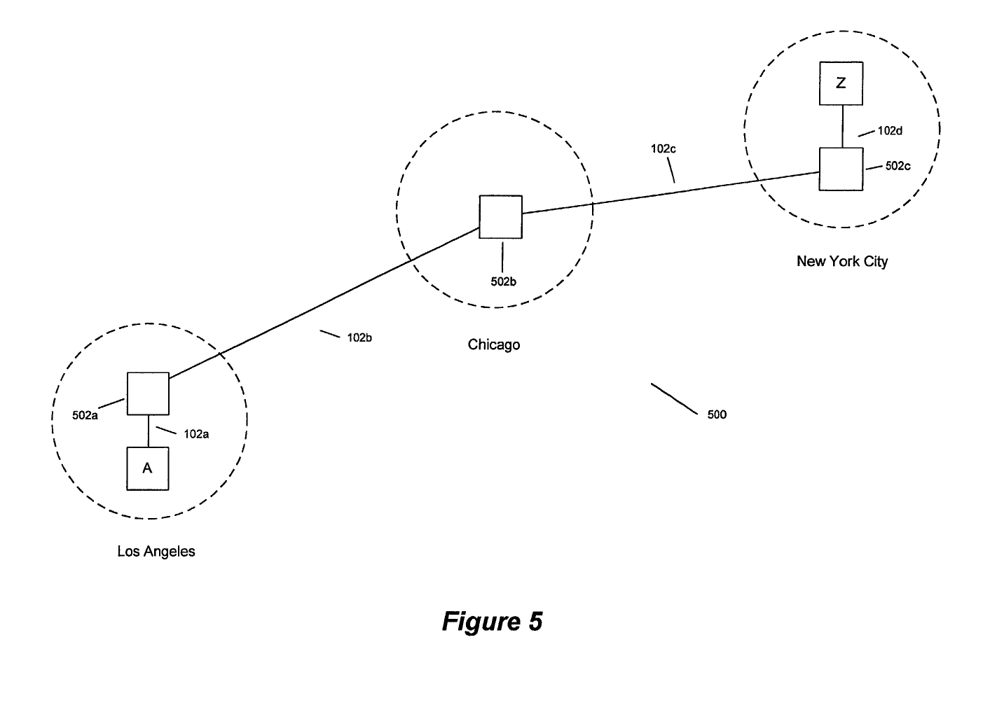

The linking of network segments 102 may be accomplished via facilitator-controlled exchange facilities 502 as shown in FIG. 5. The exchange facilities 502 are facilities that provide interconnection points between multiple transport suppliers. These facilities 502 are preferably transport supplier-neutral, in that they are controlled by the facilitator rather than any particular transport provider. The neutral nature of the exchange facilities helps to prevent the competitive tensions typically encountered when one transport supplier connects a network segment 102 to that of another transport supplier via co-location of equipment at the second supplier's interconnection facility 104.

To link multiple network segments 102 together via facilitator-controlled exchange facilities to form a provisioned circuit 500, the facilitator first orders access to the proper segments 102 from their respective transport suppliers. The facilitator communicates orders to the transport suppliers via the information exchange 102 as described with respect to FIG. 2. In placing an order, the facilitator requests that each segment terminate at a facilitator-controlled exchange terminal 502. At each exchange terminal 502, the facilitator links two or more network segments 102 together. For example, FIG. 5 shows an exemplary customized circuit between customer locations in Los Angeles and New York according to this embodiment of the invention. Four network segments 102a-d are connected to form the circuit, similar to those shown in FIG. 1. However, according to this embodiment of the invention, the network segments are linked via facilitator-controlled exchange facilities 502a-c. Because the facilitator, rather than a transport supplier, links the network segments 102a-d together, the various transport suppliers may be unaware of how their network segments are connected. As a result, a given transport supplier may not know if its network segment 102 is connected to the network of a rival transport supplier. Moreover, because the facilitator controls each exchange terminal 502, it is the facilitator, rather than any given transport supplier, that sets the terms surrounding the use of the exchange facility. Accordingly, the tensions and inefficiencies of using different network segments 102 from competing transport suppliers are substantially or completely alleviated with respect to this provisioning operation.

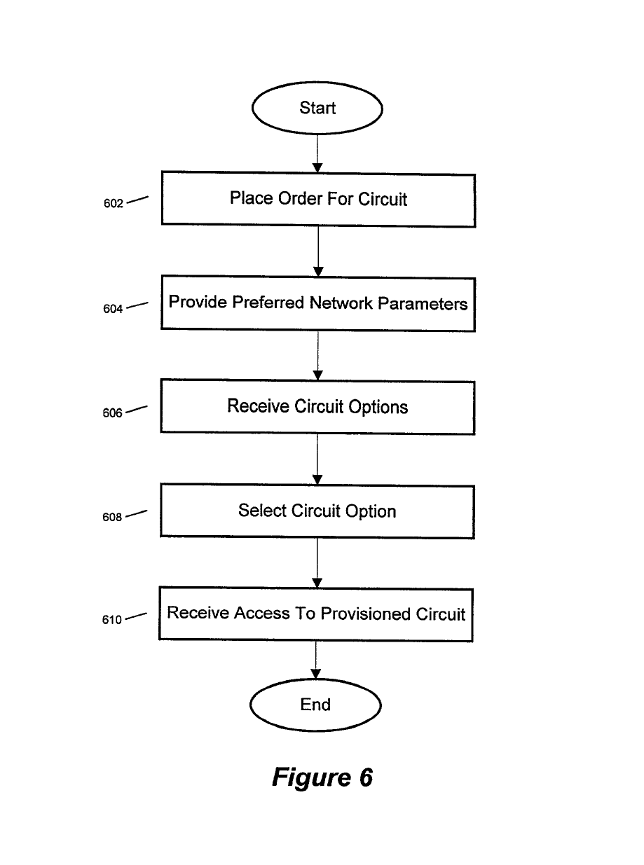

The process of ordering a circuit according to a preferred embodiment of this invention will now be discussed with reference to the flow chart of FIG. 6. In step 602, the customer orders a circuit from the facilitator. Preferably, this step 602 is accomplished via the interface system 206 and automated ordering and provisioning system 208 of the information exchange 202, as described with respect to FIG. 2. The customer may also specify certain preferred network parameters as shown by step 604. For instance, the customer may specify the terminal points of the circuit, a preferred network capacity such as DS-1 or OC-3, particular preferred routing information, and the date by which the customer needs access to the circuit. The customer may also specify preferred transport suppliers, as well as particular circuit features such as fiber/copper, redundant/non-redundant, SONET/non-SONET, and protected/non-protected. Based upon this information, the facilitator evaluates network parameter information associated with available network segments 102 to identify available circuit options. In doing so, the facilitator may consult the information exchange database 204. The facilitator may also filter the available circuit options to identify particular preferred circuit options that most closely match the customer's preferences.

The customer then receives one or more circuit options from the facilitator in step 606. Each circuit option consists of one or more network segments 102 linked together to form the complete circuit. The network segments 102 included in a particular circuit option may be from different transport providers. As described above, the network segments 102 may be linked together via facilitator-controlled exchange facilities 502, as described with respect to FIG. 5. In step 608, the customer selects one of the circuit options and communicates the selection to the facilitator via the information exchange 202. After the facilitator has provisioned the circuit by ordering the necessary network segments 102 from the proper transport suppliers, and by linking those network segments 102, the customer receives access to the provisioned circuit in step 610. Thereafter, the customer interfaces with the facilitator as a single point of contact for all billing and circuit maintenance procedures relating to each of the network segments 102 of the provisioned circuit 500.

The implementation of the various software and logic protocols necessary for operation of the present embodiments may be done through conventional means known in the art. For example, if the facilitator 250 is implemented as a software program running on a server or other system, such program may be written in a variety of high-level or low-level computer languages. The software may run on any hardware system capable of running the software and interfacing as necessary with the switching networks and other telecommunications networks described. Furthermore, the particular interfaces are known in the art, and can include relays, DSLAM interfaces, or other converters in either software or hardware form that can translate actions by the facilitator 250, interface 206, or other components with other components either outside or inside the system.

The invention has been described in detail with particular reference to preferred embodiments thereof and illustrative examples, but it will be understood that variations and modifications can be effected within the spirit and scope of the invention.

1. A method of provisioning a circuit between at least two terminal points, wherein a facilitator provisions the circuit for a customer, the method comprising the steps of:
receiving a customer request for a circuit between said at least two terminal points;
evaluating a plurality of network parameters relating to said customer request;
linking a plurality of network segments provided by a plurality of separate transport suppliers, wherein said plurality of network segments is linked via at least one facilitator-controlled exchange facility to form a provisioned circuit between said at least two terminal points; and
providing access to the provisioned circuit to said customer.

2. The method of claim 1 wherein:
said step of evaluating a plurality of network parameters further comprises consulting a database of information relating to available network segments from separate transport suppliers.

3. The method of claim 2, wherein:
the database is updated to reflect the information relating to available network segments on a real-time basis.

4. The method of claim 1, further comprising the step of:
providing a plurality of network parameter options to the customer before the step of linking said plurality of network segments to form the provisioned circuit.

5. The method of claim 1, further comprising the steps of:
identifying at least one customized circuit option; and
providing said at least one customized circuit option to the customer before the step of linking said plurality of network segments to form the provisioned circuit.

6. The method of claim 5, wherein:
the step of identifying at least one customized circuit option further comprises the step of filtering a plurality of available circuit options with respect to at least one network parameter provided by the customer.

7. The method of claim 1, wherein:
the customer request is received into an automated ordering and provisioning system.

8. The method of claim 7, wherein:
the customer accesses the ordering and provisioning system via the Internet.

9. The method of claim 1, wherein:
the segments are linked using an automated ordering and provisioning system.

10. The method of claim 1, further comprising the step of:
serving as a party of record with respect to a plurality of service agreements associated with said plurality of network segments, said plurality of service agreements being provided by said plurality of separate transport suppliers.

11. The method of claim 10, wherein:
said customer remains anonymous with respect to said plurality of separate transport suppliers throughout said method steps.

12. The method of claim 1, further comprising the step of:
providing a single point of contact for said customer in connection with billing and circuit maintenance procedures from said transport suppliers relating to said network segments.

13. A method of obtaining a provisioned circuit between at least two terminal points, the method comprising the steps of:
providing a request to a facilitator for a circuit between said at least two terminal points;
receiving at least one circuit option from said facilitator in response to said request, wherein each of said at least one circuit options comprises a plurality of network segments from separate transport suppliers, said plurality of network segments being linked via at least one facilitator-controlled exchange facility; and
selecting one of said at least one circuit options for provisioning into a provisioned circuit; and
receiving access to said provisioned circuit.

14. The method of claim 13, further comprising the step of:
providing the facilitator with at least one preferred network parameter, said at least one circuit option being chosen by said facilitator in accordance with said parameter.

15. The method of claim 13, wherein:
the step of requesting the provisioned circuit is performed via an automated ordering and provisioning system.

16. The method of claim 15, wherein:
the automated ordering and provisioning system is accessed via the Internet.

17. The method of claim 14 wherein said facilitator further comprises a software program running on a server.

18. The method of claim 14 wherein said facilitator further comprises at least one human operator.

19. A system for provisioning a circuit between at least two terminal points, said system comprising:
at least one processing server in connection with a plurality of customers;
a database resident on said at least one processing server, wherein the database is updated on a regular basis with information related to a plurality of network segments of a plurality of transport suppliers, and wherein said information is received from said plurality of transport suppliers;
a plurality of exchange facilities in communication with said at least one server for facilitating the linking of the network segments; and
logic software resident on said at least one server and in communication with the database and the facilities to automate the linking of said network segments via said exchange facilities to form a provisioned circuit in accordance with a customer request.

20. The system of claim 19 further comprising at least one facilitator for receiving said customer request and interfacing with said logic software.

21. The system of claim 20 further comprising means for evaluating said database information and means for providing a plurality of circuit options in accordance with said customer request.
